(19) United States
(12) Patent Application Publication
(10) Pub. No.: US 2025/0147337 A1
(43) Pub. Date: May 8, 2025

(54) MULTI-MATERIAL EYEWEAR DEVICE

(71) Applicant: GOOGLE LLC, Mountain View, CA (US)

(72) Inventors: Geoffrey Gudgeon, Waterdown (CA); Joshua Moore, Elora (CA)

(21) Appl. No.: 18/500,601

(22) Filed: Nov. 2, 2023

(51) Int. Cl. G02C 5/00; G02B 27/01; G02C 11/00

(52) U.S. Cl. CPC G02C 5/008; G02B 27/0176; G02C 11/10; G02B 2027/0169; G02B 2027/0178

(57) ABSTRACT

A multi-material eyewear device that can be utilized in an augmented reality (AR) or mixed reality (MR) eyewear display system includes an upper portion composed of a different material from one or more lower portions. The upper portion has a higher stiffness or stiffness-to-mass ratio than the lower portions, is less RF-permeable than the lower portions, and/or has a higher thermal conductivity than the lower portions. One or more antennas bonded to, housed in, or coextensive with the lower portions operate with high performance and efficiency due to the lower portions having higher RF-permeability than the upper portions, while the multi-material eyewear device maintains a high overall stiffness or stiffness-to-mass ratio due to the stronger material of the upper portion.

### BACKGROUND

In an augmented reality (AR) or mixed reality (MR) eyewear display, light from an image source is coupled into a light guide substrate, generally referred to as a waveguide, by an input optical coupling such as an in-coupling grating (i.e., an “incoupler”). The input optical coupling can be formed on one or more surfaces of the substrate or disposed within the substrate. Once the light has been coupled into the waveguide, the incoupled light is “guided” through the substrate, typically by multiple instances of total internal reflection, to then be directed out of the waveguide by an output optical coupling (i.e., an “outcoupler”), which can also take the form of an optical grating. The outcoupled light projected from the waveguide overlaps at an eye relief distance from the waveguide forming an exit pupil, within which a virtual image generated by the image source can be viewed by the user of the eyewear display. AR and MR eyewear displays often also utilize one or more antennas to enable communications with other devices. However, the materials of the eyewear displays can negatively impact the performance or efficiency of the antennas.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of a multi-material augmented reality eyewear display device implementing an optical waveguide in accordance with some embodiments.

FIG. 2 is a diagram illustrating a multi-material eyewear display device in accordance with some embodiments.

FIG. 3 is a diagram illustrating a multi-material eyewear display device with interlocking features in accordance with some embodiments.

FIG. 4 is a diagram illustrating antennas in lower portions of a multi-material eyewear display device in accordance with some embodiments.

FIG. 5 is a diagram illustrating a multi-material eyewear display device in an eyeglasses assembly in accordance with some embodiments.

FIG. 6 is a flow diagram of a method of manufacturing a multi-material eyewear display device in accordance with some embodiments.

### DETAILED DESCRIPTION

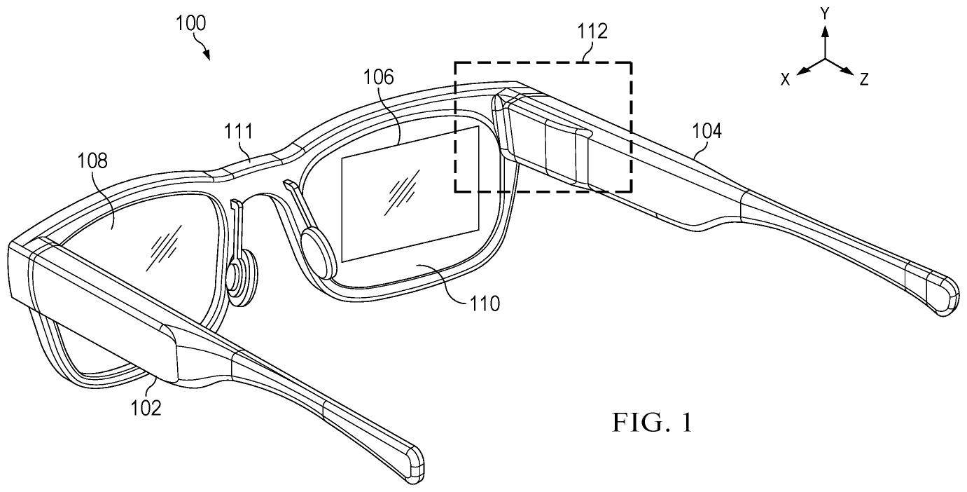

FIGS. 1-6 illustrate various techniques for implementing a multi-material eyewear device that can be utilized in an augmented reality (AR) or mixed reality (MR) eyewear display system. In some embodiments, the multi-material eyewear device includes an upper portion composed of a different material from one or more lower portions. This difference in materials can result in the upper portion having a higher stiffness or stiffness-to-mass ratio than the lower portions, being less RF-permeable than the lower portions, and/or having a higher thermal conductivity than the lower portions, which may help to dissipate heat generated by components of the multi-material eyewear device and/or an AR eyewear display system utilizing the multi-material eyewear device. By using a material with higher RF-permeability for one or both of the lower portions, one or more antennas bonded to, housed in, or coextensive with the lower portions are able to operate with higher performance and efficiency than may otherwise be possible if the upper portion and one or both of the lower portions were all composed of identical materials.

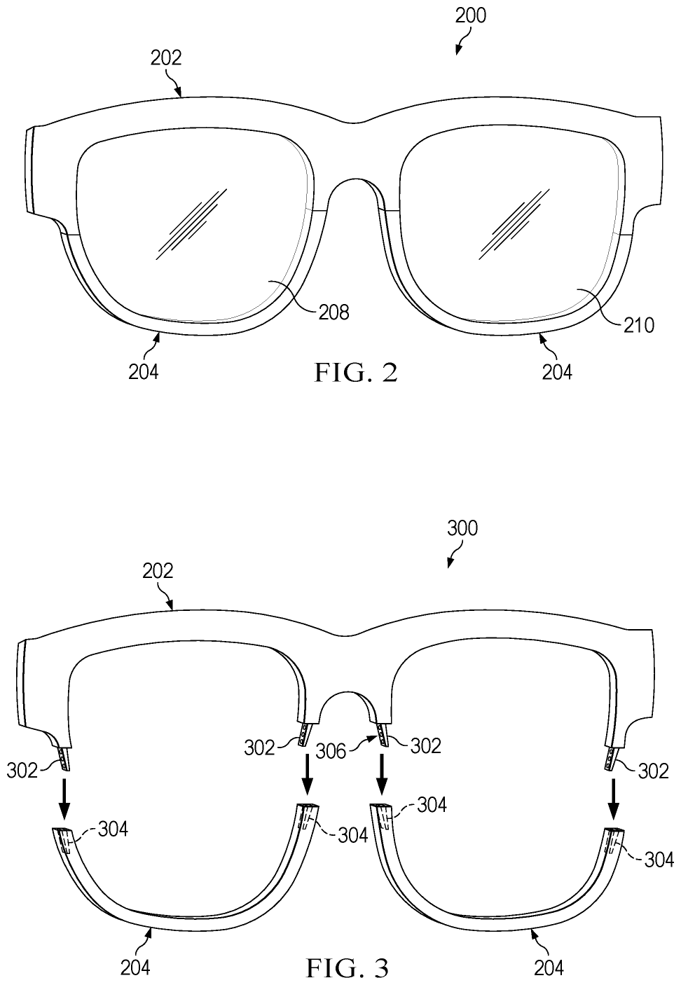

FIG. 1 illustrates an AR eyewear display system 100 implementing an optical waveguide that utilizes a multi-material eyewear device in accordance with some embodiments. The AR eyewear display system 100 includes a support structure 102 (e.g., a support frame) to mount to a head of a user and that includes an arm 104 that houses a laser projection system, an emissive micro-display (e.g., micro-light emitting diode (LED) display), or other light engine configured to project display light representative of images toward the eye of a user along a preconfigured optical path, such that the user perceives the projected display light as a sequence of images displayed in a field of view (FOV) area 106 at one or both of lens elements 108, 110 supported by the support structure 102. The support structure 102 further includes a nose bridge 111 and may include various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. In some embodiments, as described further herein in connection with FIGS. 2-6, the AR eyewear display system 100 includes a multi-material eyewear device that improves one or more characteristics of the AR eyewear display system, such as overall structural stiffness, RF-permeability, and heat dissipation characteristics.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes a spectacles or eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an augmented reality display in which rendered graphical content can be superimposed over or otherwise provided in conjunction with a real-world view as perceived by the user through the lens elements 108, 110. For example, micro-display light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide may employ an exit pupil expander (EPE) in the light path between the IC and OC, or in combination with the OC, in order to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

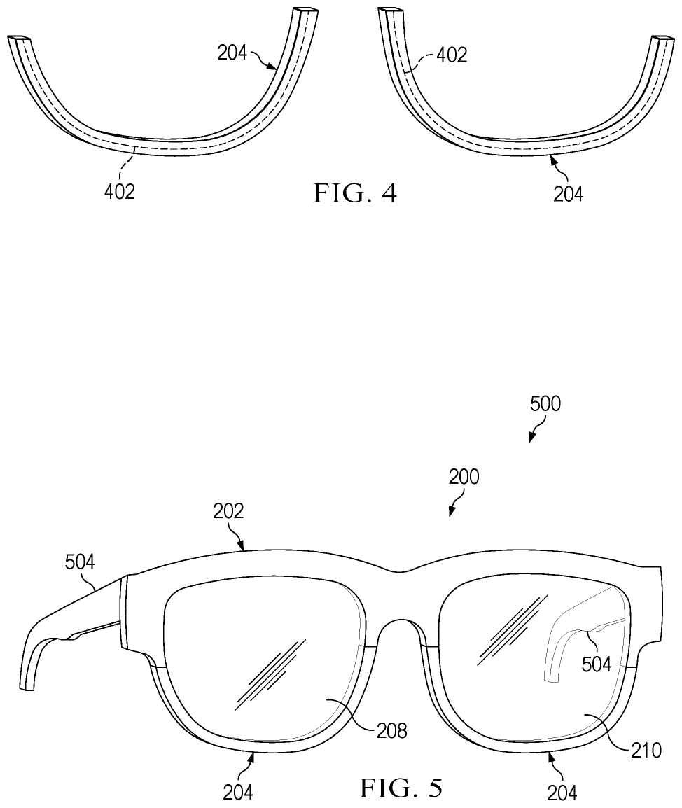

FIG. 2 is a diagram illustrating a multi-material eyewear device 200 that can be utilized in the AR eyewear display system 100 of FIG. 1 in accordance with some embodiments. For example, in some embodiments, the multi-material eyewear device 200 may be housed in or otherwise attached to the AR eyewear display system 100 of FIG. 1. The multi-material eyewear device 200 includes an upper portion 202 and one or more lower portions 204, where the upper portion 202 is composed of a different material from the one or more lower portions 204. In some embodiments, the multi-material eyewear device 200 includes lens elements 208, 210, which may correspond to lens elements 108, 110 of FIG. 1. However, in some embodiments, only one of the lens elements 208, 210 may be included in the multi-material eyewear device 200. One or more of the lens elements 208, 210 may include one or more of a waveguide, a prescription lens, a non-prescription lens, and a tinted lens. In some embodiments, the upper portion 202 spans a nose bridge such as the nose bridge 111 of the AR eyewear display system 100 of FIG. 1 or a majority (e.g., 50% or more) of a length of a lens element such as one of the lens elements 108, 110 of FIG. 1 or one of the lens elements 208, 210 of FIG. 2 in an eyewear assembly. In some embodiments, one or both of the lower portions 204 are bonded to, house, or are coextensive with an antenna (see, e.g., FIG. 4), and the one or more lens elements 208, 210 are located between the upper portion 202 and the lower portions 204.

As noted above, the upper portion 202 is composed of a different material from the one or more lower portions 204. In some embodiments, this difference in materials results in the upper portion 202 having a higher stiffness or stiffness-to-mass ratio than the lower portions 204, being less RF-permeable than the lower portions 204, and/or having a higher thermal conductivity than the lower portions 204, which may help to dissipate heat generated by components of the multi-material eyewear device 200 or the AR eyewear display system 100 of FIG. 1. By using a material with higher RF-permeability for the lower portions 204, one or more antennas (see, e.g., FIG. 4) bonded to, housed in, or coextensive with the lower portions 204 are able to operate with higher performance and efficiency than may otherwise be possible if both the upper portion 202 and the lower portions 204 were composed of identical materials.

Eyewear assemblies are often composed of materials that are resistant to breakage; however, stronger materials typically have lower RF-permeability, which can negatively affect the performance or efficiency of any antennas disposed in or proximal to such materials. When a waveguide is disposed in one or more of the lens elements 208, 210 of the multi-material eyewear device 200, in addition to avoiding breakage, it may be important to ensure that the lens elements 208, 210 maintain their positions, e.g., relative to one another or to the multi-material eyewear device 200. Ensuring that the lens elements 208, 210 maintain their positions relative to one another or to the multi-material eyewear device 200 helps to prevent any display components or projectors associated with the lens elements 208, 210 from becoming misaligned, which could otherwise negatively influence their display characteristics. Accordingly, using a different material for the upper portion 202 from the material of the lower portions 204 allows for using a stronger material with a higher stiffness or stiffness-to-mass ratio for the upper portion 202, which may also provide for higher thermal conductivity in the upper portion 202, while still allowing for the lower portions 204 to be composed of a material with higher RF-permeability such that an antenna disposed in or proximal to the lower portions 204 will operate with high performance and efficiency.

In some embodiments, in order to provide high resistance to breakage in the upper portion 202 while still allowing the lower portions 204 to be RF-permeable, the upper portion 202 is primarily (for example but not limited to 60% or more) composed of a material with a lower RF permittivity than that of the lower portions 204. In other words, the lower portions 204 are primarily composed of a material with a higher permittivity or reduced conductivity than that of the upper portion 202. For example, in some embodiments, the upper portion 202 is primarily composed of one or more of a metal, a metal alloy, and carbon fiber, which can also be used as electrical grounds, and the lower portions 204 are primarily composed of one or more of polytetrafluoroethylene (PTFE), polycarbonate (PC) foam, plastics, ceramics, glass and glass filled materials.

The term “RF-permeable” indicates how readily a material allows RF signals to pass through it, and the most RF-permeable materials are typically referred to as RF-transparent or RF-translucent. RF-permeable materials that do not significantly affect electromagnetic signals such as RF signals are typically those with low electrical conductivity and low dielectric constants. These materials minimize signal loss and interference and include materials such as PTFE and certain foam materials, plastics, ceramics, and glass. The dielectric constant (ε or relative permittivity) measures a material's ability to store electrical energy in an electric field. A low dielectric constant means the material is less able to store energy in the electric field, which is typically associated with weaker polarization effects when exposed to an electric field. Electrical conductivity measures a material's ability to conduct electrical current. Materials with low electrical conductivity do not allow the easy flow of electrical current and are typically insulators or have high resistivity. Accordingly, selecting materials with low dielectric constants and/or low electrical conductivity for the lower portions 204 helps to minimize signal loss, distortion, and interference and limit any adverse effect the electromagnetic properties of the materials may have on the performance of any antennas disposed in or proximal to the lower portions 204.

In some embodiments, in order to provide high resistance to breakage and less potential for bending in the upper portion 202 while still allowing the lower portions 204 to be RF-permeable, the upper portion 202 has a higher Young's Modulus or Shear Modulus than the lower portions 204. Young's Modulus quantifies a material's stiffness under tensile or compressive stress, such as may occur when bending a material, while Shear Modulus, sometimes referred to as the modulus of rigidity, is used to describe a material's resistance to shear stress, such as may occur when applying a twisting or torsional force to a material.

Although a particular arrangement of the upper portion 202 and the lower portions 204 is shown in FIG. 2, different arrangements may be used. For example, the lower portions 204 may be shorter or longer, and likewise the upper portion 202 may extend down toward the lower portions 204 to a greater or lesser extent. In some embodiments, the lower portions 204 may be connected, forming a monolithic component lower portion, such that the monolithic lower portion forms a portion of the nose bridge located centrally between the left- and right-hand portions of the upper portion 202. In some embodiments, other materials may be located between the upper portion 202 and the lower portions 204, such as one or more adhesives that secure the lower portions 204 to the upper portion 202 or other materials.

FIG. 3 is a diagram illustrating a multi-material eyewear device 300 similar to the multi-material eyewear device 200 of FIG. 2 with interlocking features in accordance with some embodiments. As shown in FIG. 3, in some embodiments, the multi-material eyewear device 300 includes interlocking features 302 such as posts or tabs attached to the upper portion 202 that are locked in place in the lower portions 204 when the lower portions 204 are attached to the upper portion 202 or otherwise formed, e.g., using injection molding in an overmolding process, such that the interlocking features 302 are secured within cavities 304 of the lower portions 204. As shown in FIG. 3, the interlocking features may include through-holes 306 that help to ensure that the lower portions 204 cannot be easily removed from the upper portion 202 after the lower portions 204 are overmolded onto the upper portion 202, although other features such as barbs may be used in addition or in place of the through-holes 306.

In some embodiments, the lower portions 204 include undercuts, slots, or holes the interlocking features 302 interface with to lock the upper portion 202 in place with the lower portions 204, with or without the use of adhesive. In some embodiments, the lower portions of the upper portion 202 are wedge-shaped and the upper portions of the lower portions 204 are wedge-shaped such that the wedges overlap and are locked together using one or more of an adhesive, magnets, overmolded features, and a joint such as a tongue and groove joint. In some embodiments, the upper portion 202 may be secured to or monolithically formed with the lower portions 204 using a gradient of material, e.g., varying from the material of the upper portion 202 to the material of the lower portions 204, such as may be implemented using 3D (three-dimensional) printing (e.g., stereolithography, selective laser sintering, fused deposition modeling, digital light process, multi-jet fusion, direct metal laser sintering, or electron beam melting). Generally, the upper portion 202 and the lower portions 204 may be secured to or collocated with each other using any appropriate methods or techniques known in the manufacturing arts. For example, in some embodiments, the upper portion 202 and the lower portions 204 are secured to the support structure 102 of the AR eyewear display system 100 of FIG. 1 using adhesive or enclosed within the AR eyewear display system 100 such that the upper portion 202 and the lower portions 204 are collocated but not directly secured to each other.

FIG. 4 is a diagram illustrating antennas 402 located in or proximal to the lower portions 204 of the multi-material eyewear device 200 of FIG. 2 or the multi-material eyewear device 300 of FIG. 3 in accordance with some embodiments. As shown in FIG. 4, the lower portions 204 are coextensive with the antennas 402. Although the antennas 402 are illustrated as spanning a majority of the length of the lower portions 204, in some embodiments, the antennas 402 are shorter than the lower portions or span the entire lengths of the lower portions. Additionally, as alluded to above, in some embodiments, only one of the lower portions 204 includes an antenna 402. In some embodiments, multiple antennas 402 are collocated with one or both of the lower portions 204 (e.g., two or three per portion), which may be positioned sequentially along the length of the lower portions 204 such that a first antenna terminates where a second antenna begins or may be positioned parallel to each other such that multiple antennas 402 overlap along the length of one or both of the lower portions 204. In some embodiments, the antennas 402 are overmolded or otherwise secured within one or more of the lower portions 204 such that the lower portions 204 house the antennas 402. In some embodiments, the antennas 402 are bonded to an exterior face or slot in the lower portions 204, e.g., using adhesive.

In some embodiments, rather than being located in one or more of the lower portions 204, one or more antennas are located in the upper portion 202 of the multi-material eyewear device 200 and the one or more lower portions 204 have a higher stiffness or stiffness-to-mass ratio than the upper portion 202, are less RF-permeable than the upper portion 202, and/or have a higher thermal conductivity than the upper portion 202, effectively swapping the material characteristics described above in connection with FIG. 2 between the upper portion 202 and the lower portions 204. In some embodiments, the placement of the antennas 402 within the multi-material eyewear device 200 depends on the expected location of other antennas with which the multi-material eyewear device 200 will interface. For example, if for example a mobile phone held in a hand or a pocket is the primary device with which the multi-material eyewear device 200 is expected to interface, one or more antennas may be disposed in or proximal to the lower portions 204 like antennas 402 of FIG. 4. However, if, for example, an overhead router or cellular tower is the primary device with which the multi-material eyewear device 200 is expected to interface, one or more antennas may be disposed in or proximal to the upper portion 202 with correspondingly swapped materials between the upper portion 202 and the lower portions 204 as discussed above.

FIG. 5 is a diagram illustrating an eyeglasses assembly 500 including the multi-material eyewear device 200 of FIG. 2 in accordance with some embodiments. As noted above, in some embodiments, the multi-material eyewear device 200 may be housed or otherwise attached to an AR eyewear display system such as the AR eyewear display system 100 of FIG. 1. In some embodiments, such an AR eyewear display system includes world-facing and/or eye-facing lenses collocated with one or more of the lens elements 208, 210 of the multi-material eyewear device 200. However, in some embodiments, the multi-material eyewear device 200 may be used independently from an AR eyewear display system such as the AR eyewear display system 100 of FIG. 1. For example, as shown in FIG. 5, in some embodiments, the multi-material eyewear device 200 is attached to arms 504 of the eyeglasses assembly 500, which may or may not provide AR functionality. For example, rather than or in addition to AR functionality, in some embodiments, the eyeglasses assembly 500 may include one or more of speakers or other audio playback mechanisms, a transparent or non-transparent display or other video playback mechanisms, or vibrational mechanisms. These mechanisms may act to notify a user of events such as exceeding a speed limit while driving or entering a restricted area such as a hardhat zone or other hazardous area or to notify a user of proximity to a location, such as an area with public WiFi, or to another user.

Additionally, although the support structure 102 of the AR eyewear display system 100 of FIG. 1 is shown as being composed of a single material, in some embodiments, the support structure 102 includes different materials similar to and approximately collocated with those of the multi-material eyewear device 200. For example, an upper portion of the support structure 102 may contain materials analogous or identical to those of the upper portion 202 of the multi-material eyewear device 200, while a lower portion of the support structure 102 may contain materials analogous or identical to those of the lower portions 204 of the multi-material eyewear device. In some embodiments, a front world-facing portion of the support structure 102 includes a single material (and may include a world-facing lens) while a rear eye-facing portion of the support structure 102 includes different materials analogous or identical to those of the multi-material eyewear device 200 (and may include an eye-facing lens). In some embodiments, the multi-material eyewear device 200 is located between a front world-facing portion and a rear eye-facing portion of the support structure 102.

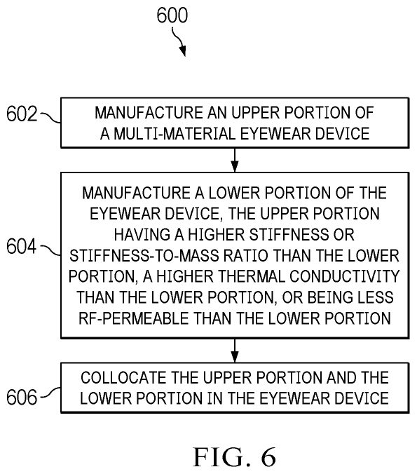

FIG. 6 is a flow diagram of a method 600 of manufacturing a multi-material eyewear device such as the multi-material eyewear device 200 of FIG. 2 or the multi-material eyewear device 300 of FIG. 3 in accordance with some embodiments. At block 602, an upper portion of an eyewear device, such as the upper portion 202 of the multi-material eyewear device 200 of FIG. 2 or the multi-material eyewear device 300 of FIG. 3, is manufactured using a first material. At block 604, a lower portion of the eyewear device, such as one of the lower portions 204 of the multi-material eyewear device 200 of FIG. 2 or the multi-material eyewear device 300 of FIG. 3, is manufactured using a second material different from the first material. In some embodiments, the first material has a higher stiffness or stiffness-to-mass ratio than the second material. In some embodiments, the first material has a higher thermal conductivity or is less RF-permeable than the second material. At block 606, the upper portion and the lower portion are collocated in the multi-material eyewear device either by securing the upper and lower portions to or within a housing such as the support structure 102 of the AR eyewear display system 100 of FIG. 1 or by securing the upper and lower portions directly to one another using, e.g., adhesives, a material gradient, or overmolding. Notably, particularly in the cases of using material gradients, e.g., with 3D printing techniques, or by overmolding the lower portion onto the upper portion, block 604 and block 606 may occur substantially simultaneously or block 606 may occur as a direct consequence of block 604.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear device comprising:
a lens element; and
a support frame comprising:
an upper portion spanning at least one of a nose bridge and at least half of a length of the lens element; and
a lower portion associated with an antenna, wherein the upper portion has a higher stiffness than the lower portion,
wherein the lens element is located between the upper portion and the lower portion.

2. The eyewear device of claim 1, wherein the upper portion is less RF-permeable than the lower portion.

3. The eyewear device of claim 1, wherein the upper portion is primarily composed of a first material with a first permittivity or conductivity and the lower portion is primarily composed of a second material with a second permittivity or conductivity higher than the first permittivity or conductivity.

4. The eyewear device of claim 1, wherein the upper portion is primarily composed of one or more of a metal, a metal alloy, and carbon fiber and the lower portion is primarily composed of one or more of Polytetrafluoroethylene, foam, plastics, ceramics, and glass.

5. The eyewear device of claim 1, wherein the upper portion has a higher Young's Modulus or Shear Modulus than the lower portion.

6. The eyewear device of claim 1, wherein the upper portion has a higher thermal conductivity than the lower portion.

7. The eyewear device of claim 1, wherein the lower portion is secured to the upper portion.

8. The eyewear device of claim 1, wherein the lens element includes a waveguide and the eyewear device is included in an augmented reality (AR) eyewear display system.

9. An eyewear device comprising:
a lens element; and
a support frame, including:
an upper portion spanning at least one of a nose bridge and at least half of a length of the lens element; and
a lower portion associated with an antenna, wherein the upper portion is less RF-permeable than the lower portion,
wherein the lens element is located between the upper portion and the lower portion.

10. The eyewear device of claim 9, wherein the upper portion is primarily composed of a first material with a first permittivity or conductivity and the lower portion is primarily composed of a second material with a second permittivity or conductivity higher than the first permittivity or conductivity.

11. The eyewear device of claim 9, wherein the upper portion is primarily composed of one or more of a metal, a metal alloy, and carbon fiber and the lower portion is primarily composed of one or more of Polytetrafluoroethylene, foam, plastics, ceramics, and glass.

12. The eyewear device of claim 9, wherein the upper portion has a higher stiffness or stiffness-to-mass ratio than the lower portion.

13. The eyewear device of claim 9, wherein the upper portion has a higher Young's Modulus or Shear Modulus than the lower portion.

14. The eyewear device of claim 9, wherein the upper portion has a higher thermal conductivity than the lower portion.

15. An eyewear device comprising:
a lens element; and
a support frame, including:
an upper portion spanning at least one of a nose bridge and at least half of a length of the lens element; and
a lower portion associated with an antenna, wherein the upper portion has a higher thermal conductivity than the lower portion,
wherein the lens element is located between the upper portion and the lower portion.

16. The eyewear device of claim 15, wherein the upper portion is less RF-permeable than the lower portion.

17. The eyewear device of claim 15, wherein the upper portion is primarily composed of a first material with a first permittivity or conductivity and the lower portion is primarily composed of a second material with a second permittivity or conductivity higher than the first permittivity or conductivity.

18. The eyewear device of claim 15, wherein the upper portion is primarily composed of one or more of a metal, a metal alloy, and carbon fiber and the lower portion is primarily composed of one or more of Polytetrafluoroethylene, foam, plastics, ceramics, and glass.

19. The eyewear device of claim 15, wherein the upper portion has a higher stiffness or stiffness-to-mass ratio than the lower portion.

20. The eyewear device of claim 15, wherein the upper portion has a higher Young's Modulus or Shear Modulus than the lower portion.
